(19) United States
(12) Patent Application Publication
(10) Pub. No.: US 2006/0118344 A1
(43) Pub. Date: Jun. 8, 2006

(54) Electrically-propelled vehicle with individual wheel drive

(76) Inventor: Thomas Rosch, Immenstaad (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/516,760

(22) PCT Filed: Jun. 5, 2003
(86) PCT No.: PCT/EP03/05884

§ 371 Date: Dec. 3, 2004

(30) Foreign Application Priority Data
Jun. 11, 2002 (DE) 102 25 731.0

(51) Int. Cl. B60K 1/00

(52) U.S. Cl. 180/65.1

(57) ABSTRACT

A multi-axle driven, all terrain vehicle with electrically driven individual wheels, having a vehicle underbody (2) and a plurality of drive wheels (4) to which, respectively, one drive with at least one electric motor (18) is assigned. The electric drive motor (18) is at least partially located in an axial space (20) which is occupied by a drive wheel, but is placed radially outside of the drive wheel (4), is proposed a housing of a connecting gear-train (14), of which housing is rigidly bound to the vehicle underbody (2) and the torque transmitting connection from the connecting gear-train (14) to the drive wheel (4) is made by a jointed shaft (8), so that the unsprung mass of each drive wheel remains small and so that in the middle of the vehicle a broad through passage can exist.

The invention concerns an electrically driven vehicle with a plurality of drive wheels of which each has been assigned one electric motor.

For vehicles with individual electrically driven wheels, a number of different concepts exist as to how the drive of the vehicle should be arranged.

In one concept, in the case of armored vehicles in the underbody, the drive motors are to be placed in the vehicle chassis with an axially extending drive gear-train. The disadvantage of this arrangement is that space between the wheels is taken up by the drive motors and is not available for other installations.

In the case of another known concept, the driving motors are placed in the wheel hubs. Thereby, the space between the drive wheels is generally free from the drive components. Disadvantages in this case are, however, that the sprung mass in the wheel is very great so that thermal problems evolve in damping elements, especially in the case of high speeds in free country. The available working room in the wheel hub is very limited, so that larger electric motors, such as asynchronous (induction) motors, are very difficult or are poor choices to choose for use and require expensive permanent magnet motors. Even more disadvantageous aspects arise with this concept, especially in the case of vehicles employed in military applications. That would be, in the case of hub-placed motors, it is extremely difficult to hold the heat and noise levels of the drive mechanisms within an acceptable range. Thereby, even a case with wheels, which are standing partially under water, i.e., a so-called “water operation”, it is necessary to furnish complex sealing means on and around the wheel hub. Relatively extensive supply and cooling lines are also required which, as is common with the motor, these are poorly protected against fire-power and environmental influences.

In DE 196 17 165 A1 and EP 0 966 361 B1 electrically driven vehicles with a chassis and a plurality of drive wheels are made known, which respective wheels are provided with a drive having at least one electric motor. In this case, the electric motor, at least partially, is placed in an axially available installation space, which is radially outside that space occupied by the drive wheel. The drive-related connection of the driving motor with the drive wheel is carried out with a gear-train connection based on spur gears, the housing of which is placed on the that side of the drive wheel and the driving motor which is proximal to the mid-zone of the vehicle. This arrangement enables the installation of larger asynchronous motors without particularly limiting the available space between the drive wheels. The disadvantage of this design is the sprung mass is similarly as high as that of the wheel hub-placed drives and only a limited displacement distance of the spring is permitted. These concepts are not applicable for wheels which are joined together so that they should not be considered in cases of multi-axle vehicles for all-terrain driving.

Thus, the purpose of the invention is to make an electrically driven vehicle available, which can travel at high speeds under all-terrain conditions wherein the wheels exhibit a low sprung mass and permit an adequate spring displacement and which provides an ample passage space within the interior of the vehicle even with the installation of larger sized asynchronous motors and, beyond this, is adaptable for wheels which can be steered. Moreover, the heat and noise emissions passed to the environment are kept at a low level and driving through shallow water is possible.

This purpose is achieved by an electrically driven vehicle which exhibits the features of the characterized parts of the principal claim. Advantageous developments of the invention are made evident by the subordinate claims.

The vehicle, according to the invention, will also have the following features; the electric motor of each drive wheel is at least partially placed in an axial available space, radially separated from the space occupied by the drive wheel, a housing of a connecting gear-train, which torque-transmittingly binds the electric motor and the drive wheel together and the driving motor is rigidly affixed to the vehicle underbody. Between the output drive of the connecting gear-train and the drive wheel, a jointed shaft is provided which, by means of a universal joint, is bound to the output shaft of the connecting gear-train. In this way, a very favorable occupation of available space is carried out; the sprung mass of the respective drive wheel is very small and the electric motor is protected inside of the underbody of the vehicle.

In an advantageous embodiment, sealing elements are provided so that the electric motor is protected from the invasion of water within the underbody of the vehicle and the immediate zone of the motor remains dry, even if the drive wheel is entirely or partially underwater.

In a variant of this embodiment, the housing of the connecting gear-train penetrates the vehicle underbody and, between the vehicle underbody and the housing of the connecting gear-train, a sealing system is in effect. In an alternative to this, the entire gear-train is made to be water tight inside the vehicle underbody so that only the jointed shaft, which also penetrates the vehicle underbody, is obliged to pass through a sealed off opening.

The invented arrangement of the individual wheel drive does not entail any limitation as to the kind of wheel suspension employed. Thus it is possible to provide linked drive wheels on one axle of the vehicle, which are pivotally suspended and provided with a steering apparatus. Likewise, no limitation exists with regard to the number of the wheels and axles.

Further embodiments of the invention are explained with the aid of the attached Figures. There is shown in schematic form:

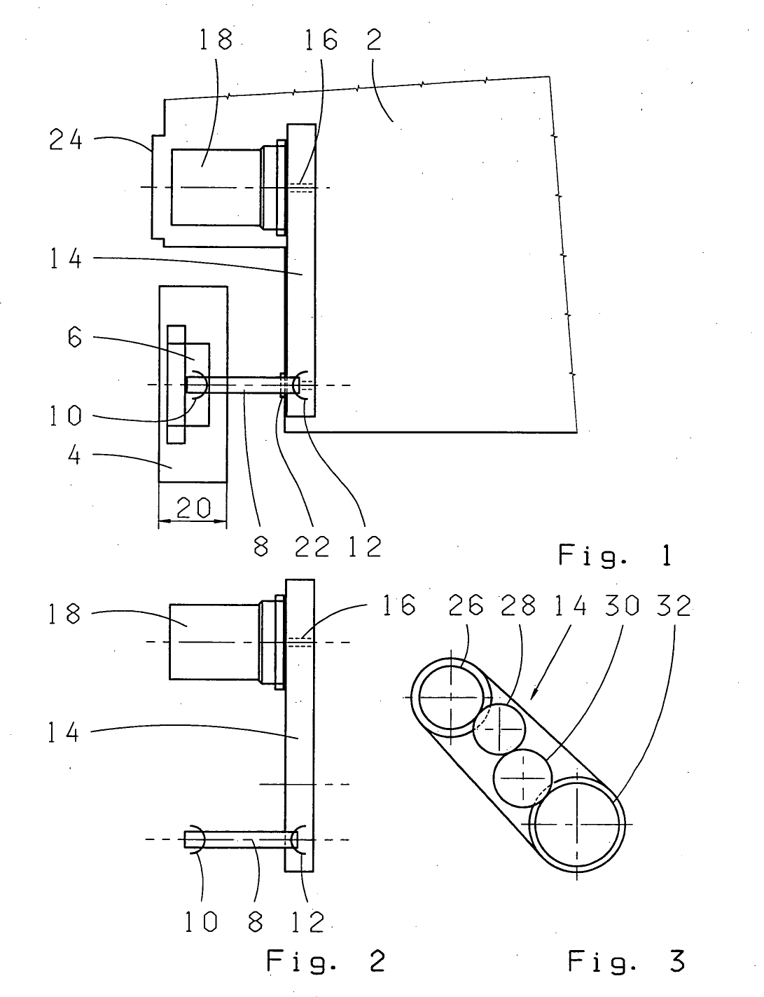

FIG. 1 is a plan view onto a section of a vehicle underbody with an invented individual wheel drive;

FIG. 2 is a top view of a driving gear-train of an invented individual wheel drive;

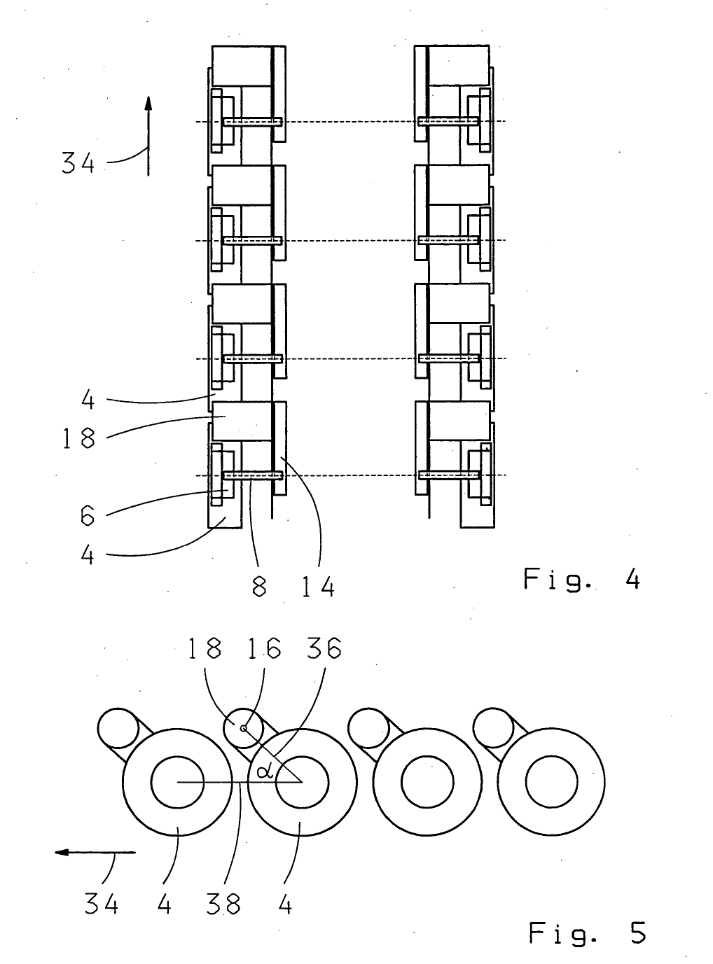

FIG. 3 is a side view of a connecting gear-train;

FIG. 4 is a top view onto a vehicle with eight individual wheel drives;

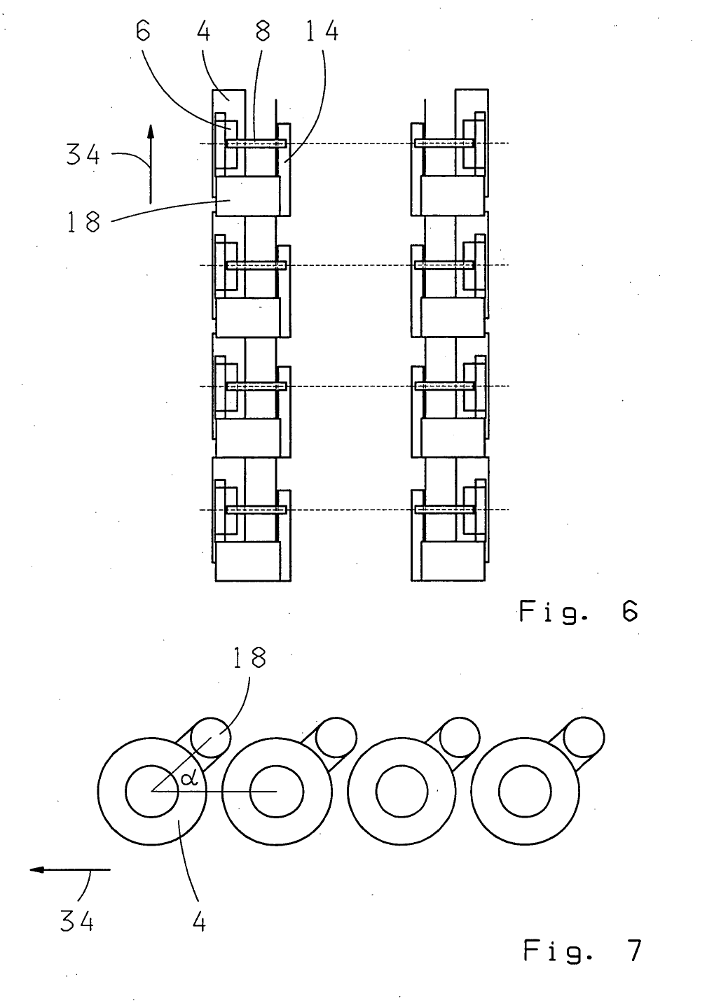

FIG. 5 is a side view of a vehicle in accord with FIG. 4;

FIG. 6 is a top view of a vehicle with eight individual drive wheels;

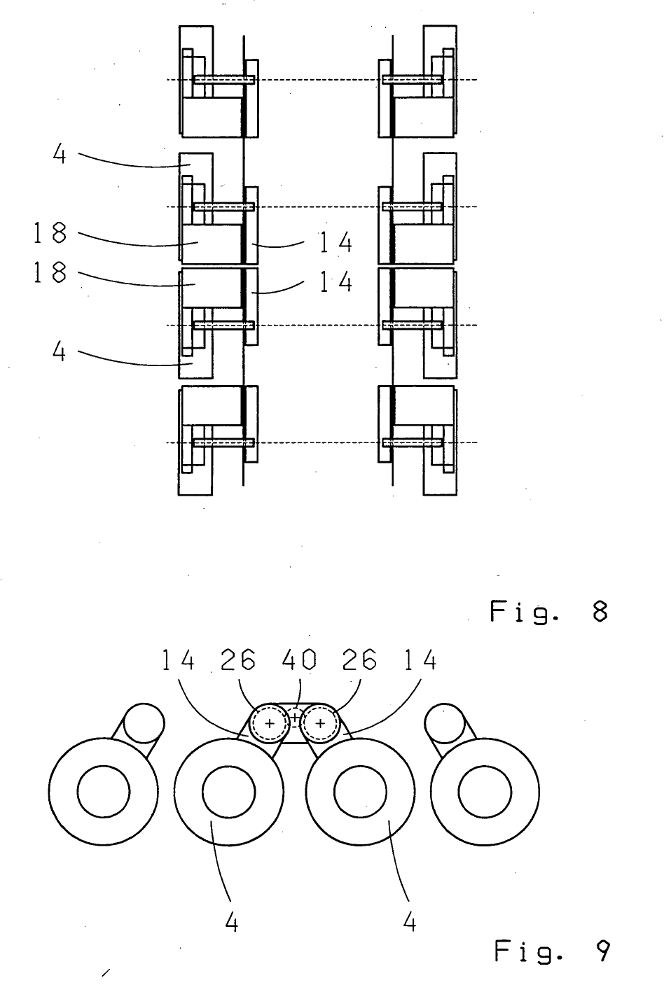

FIG. 7 is a side view of a vehicle in accord with FIG. 6;

FIG. 8 is a top view of a vehicle with eight individual drive wheels;

FIG. 9 is a side view of the vehicle in accord with FIG. 8;

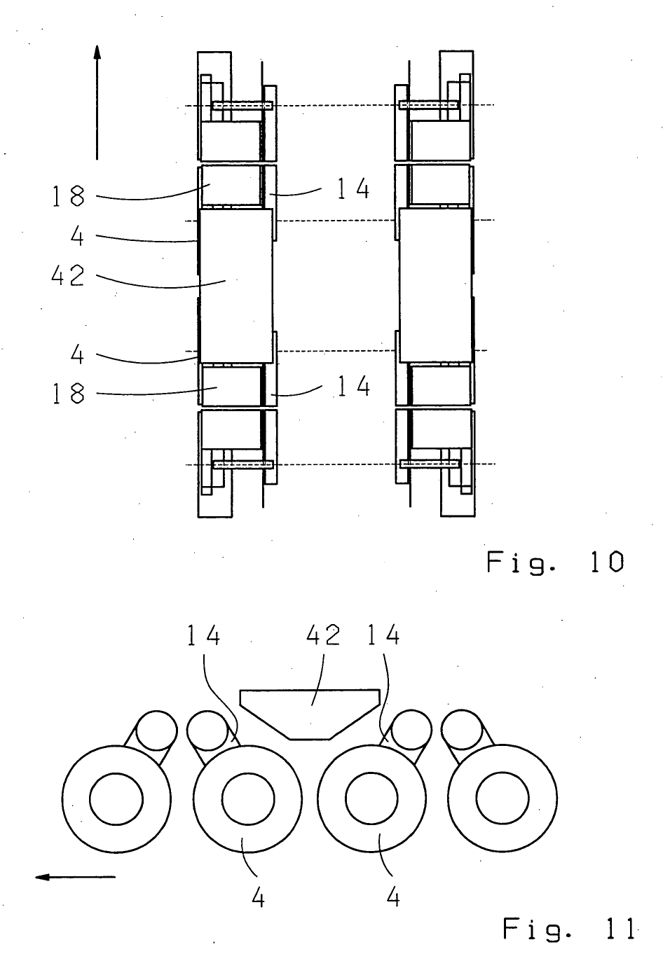

FIG. 10 is a top view of a vehicle with eight individual drive wheels; and

FIG. 11 is a side view of the vehicle in accord with FIG. 10.

In FIG. 1, a reference number 2 denotes a rear, left section of a vehicle underbody wherein the vehicle is a multi-axle all-terrain vehicle. In a drive wheel 4 is placed a wheel head gearing 6 in the form of a planetary gear set. A jointed shaft 8 possesses pivotal linkages 10, 12 on both its ends, which enable toe-in or side deflection of the wheel 4. At the linkage 10, the jointed shaft 8 is so connected to the input of the wheel head, planetary gearing 6, that it can transmit torque thereto. At the linkage 12, the jointed shaft 8 is connected to an output of the connecting gear-train 14, the housing of which is rigidly bound to the underbody 2 of the vehicle. At the torque input end, the connecting gear-train 14 is connected with a drive shaft 16 of an electric drive motor 18. The drive motor 18, with its end which is proximal to the outside of the vehicle, is partially in an axial space 20 occupied by the drive wheel 4, but radially offset from the drive wheel 8. The housing of the connecting gear-train 14 is placed on that side of the drive wheel 4 and the drive motor 18, which is proximal to the center of the vehicle. The area of the underbody within the connecting gear-train remains free from components of the drive, so that a free passage is allowed within the vehicle. The unsprung mass of the drive wheel 4 is small, since the connecting gear-train 14 and the drive motor 18 of the vehicle underbody 2 are sprung mounted. A sealing collar 22 is provided immediately in the area of the penetration of the jointed shaft 8 through the vehicle underbody 2. The drive motor 18 and the connecting gear-train 16 are also waterproofed as they are placed inside the vehicle underbody and remain dry, even if the drive wheels 4 are entirely or partially immersed in water. The underbody 2 possesses an opening on the outside in an axial lengthening of the drive motor 18, so that the drive motor is accessible for installation and maintenance purposes from the outside. This opening can be closed by a cover 24. The drive motor 18 and the connecting gear-train 14 are totally isolated from the effects of environmental conditions as well as being fired upon as they are within the armored vehicle underbody 2. Also, at this location, the generation of undesirable heat and noise emissions is very small.

In FIG. 2, the same positions are designated with the same reference numbers as is the case in FIG. 1.

The connecting gear-train 14, as presented in FIG. 3, is shown here, for example, as a spur gear chain and includes four spur gears 26, 28, 30, 32, which are placed to rotate in the housing of the connecting gear-train 14. The connecting gear-train 14 can be assembled at little cost to meet various gear ratios, so that matching an entire gear ratio would be very easy to bring about. Dependent upon the separating distance of the axles, also another number of spur gears in the train are possible so that this lies in a further appropriate train other than three spur gears. Instead of a spur gear chain, it is also possible to use a chain or belt drive with associated sheaves and gearing.

In the presentation as shown in FIG. 4, once again, the same positions with the same reference numbers are employed as was the case in FIG. 1. In this illustrated vehicle, each wheel 4 of the vehicle is assigned a drive motors 18 and a connecting gear-train 14. The drive motors 18 are respectively placed in a space above the axis of rotation of the drive wheels 4, between two neighboring drive wheels in a direction of travel 34 in front of the assigned drive wheel 4. Following this arrangement, a connection line 36, between the axis of rotation of the drive wheel 4 and the shaft 16 of the drive motor 18, intercepts a connection line 38 between the axis of rotation of two neighboring drive wheels 4, thereby closing an angle α, which should lie between 30° and 75° (see FIG. 5).

FIGS. 6 and 7 show a configuration wherein the drive motors 18 respectively lie behind the axis of rotation of the assigned drive wheels 4.

In FIGS. 8 and 9 is presented a configuration wherein the connecting gear-drives 14 with the assigned drive motors 18 of the centrally located neighboring drive wheels 4, which are situated behind one another, are angularly inclined toward each another so that the axes of rotation of the drive shafts of the drive motors lie in a horizontal direction between the axes of rotation and the drive wheels 4. This configuration is then of advantage if, because of redundant reasons, the drive motors 18 of the neighboring drive wheels 4 are torque-transmittably coupled with one another or should be so coupled, as is indicated in FIG. 9 by spur gears 26, 40.

Alternatively to this and referring to FIGS. 10 and 11, a configuration is shown wherein the connecting gear-train 14 with the drive motors 18 of two neighboring successively located drive wheels 4 are now inclined away from one another. In this manner, in the zone above and between the two drive wheels 4, an open free space is created, which stands available for large assemblies and equipment, such as an energy reclamation unit 42 for the electric motors 18. At this location, the energy reclamation unit 42, which typically consists of a diesel motor and a generator, is excellently accessible from the outside through corresponding maintenance openings and the passage through the center of the vehicle remains free.

### Reference Numerals

2 Underbody of vehicle

4 Drive wheel

6 Wheel head gearing (planetary)

8 Jointed shaft

10 Linkage

12 Linkage

14 Connecting gear-train

16 Shaft

18 Drive motor

20 Axial space (available for equipment)

22 Sealing collar

24 Cover

26, 28 Spur gears

30, 32 Spur gears

34 Direction of travel

36 Connection line

38 Connection line

40 Spur gear

42 Energy reclamation unit

1-17. (canceled)

18. An electrically driven multi-axle all terrain vehicle, with a vehicular underbody (2) and a plurality of drive wheels (4), one drive with at least one drive motor (18) being assigned to each of the plurality of drive wheels (4), whereby each of the drive motors (18) is at least partially located in an available space (20) occupied by the drive wheel (4) but radially offset outward from the drive wheel (4) and for a torque transmitting connection of the drive motor (18) with the drive wheel (4), a connection gear-train (14) with a housing is provided, which is placed on a side of the drive wheel (4) and the drive motor (18) which is proximal to a center of the vehicle,
the housing of the connecting gear-train (14) is rigidly affixed to the underbody (2) of the vehicle and in that between an output shaft of the connection gear-chain and the drive wheel, a jointed shaft (8) is provided, which by means of an end linkage (12) is bound to the output shaft of the connecting gear-train (14).

19. The vehicle according to claim 18, wherein the drive motor is made waterproof within the vehicle underbody (2), so that an area of the drive motor (18) remains dry, when the drive wheel (4) is either entirely or partially under water.

20. The vehicle according to claim 19, wherein the housing of the connecting gear-train (14) penetrates the vehicle underbody (2), and between the vehicle underbody (2) and the housing of the connecting gear-train (14), a sealing means has been provided.

21. The vehicle according to claim 19 wherein the entire connecting gear-train (14) is placed waterproofed within the vehicle underbody (2), and the jointed shaft (8) penetrates the vehicle underbody (2), and a sealing collar (22) is provided between the jointed rod (8) and the vehicle underbody (2).

22. The vehicle according to claim 18, wherein at least two drive wheels (4), which are situated on one axle of the vehicle, are pivotally suspended and can be steered from a steering mechanism.

23. The vehicle according to claim 18, wherein the drive wheel (4) accepts a wheel-head transmission (6), which is bound on a drive side with the jointed shaft (8).

24. The vehicle according to claim 18, wherein the connection gear-train (14) is designed as a spur-gear-chain (26, 28, 30, 32).

25. The vehicle according to claim 18, wherein the connection gear-train (14) is designed as a belt driven means of torque transmission.

26. The vehicle according to claim 18, wherein the vehicle underbody (2) possesses on an outside, in an area of the drive motor (18) an opening which can be closed by a cover (24).

27. The vehicle according to claim 18, wherein a connecting line (36) between an axis of rotation of the drive wheel (4) and an axis of rotation of the drive shaft of the drive motor (18) intersects with the connecting line (38) of a rotational axes of two neighboring drive wheels (4) to close an angle (α), which has a value between 30° and 75°.

28. The vehicle according to claim 18, wherein each drive wheel (4) of the vehicle is assigned to the at least one drive motor (18) and the connecting gear-train (14).

29. The vehicle according to claim 18, wherein the connection gear-train (14) with the drive motors (18) of two neighboring, drive wheels (4), which are located behind one another, are inclined toward one another, so that an axis of rotation of drive shafts of the drive motors (18) lie in a horizontal direction between an axes of rotation of the drive wheels (4).

30. The vehicle according to claim 29, wherein the drive motors (18) of the two neighboring drive motors (4) are torque transmittingly coupled, or are so coupled, with one another.

31. The vehicle according to claim 18, wherein the connection gear-train (14) with the drive motor (18) of two neighboring drive wheels (4), which are located one after another, are inclined away from one another, so that a free space, in a zone above and between the two neighboring drive wheels (4), is created.

32. The vehicle according to claim 31, wherein in the free space at least parts of energy recovery units (42) for the electric motors (18) are placed.

33. The vehicle according to claim 18, wherein the drive motor (18) and the connecting gear-train (14) comprise a drive unit.

34. A drive unit according to claim 18, consisting of a drive motor (18) and a connecting gear-train (14) for use in a vehicle.

35. A connecting gear-train of a drive unit according to claim 34.
